(19) United States
(12) Patent Application Publication
(10) Pub. No.: US 2017/0159609 A1
(43) Pub. Date: Jun. 8, 2017

(54) TURBOFAN AIRCRAFT ENGINE WITH REDUCED NOISE EMISSION

(71) Applicant: MTU Aero Engines AG, Munich (DE)

(72) Inventors: Carsten SCHOENHOFF, Munich (DE); Rudolf STANKA, Rattenkirchen (DE); Erich STEINHARDT, Munich (DE); Claus RIEGLER, Karlsfeld (DE); Stephen Royston WILLIAMS, Seefeld (DE); Hans-Peter HACKENBERG, Olching (DE); Eckart HENRICH, Germering (DE); Stefan WEBER, Munich (DE); Klaus Peter RUED, Munich (DE); Hermann KLINGELS, Dachau (DE); Patrick WACKERS, Munich (DE); Christoph BICHLMAIER, Greifenberg (DE); Stefan BUSAM, Greifenberg (DE); Matthias KROBOTH, Augsburg (DE); Norbert HUEBNER, Dachau (DE)

(21) Appl. No.: 15/090,805

(22) Filed: Apr. 5, 2016

Related U.S. Application Data
(60) Provisional application No. 62/263,227, filed on Dec. 4, 2015.

(51) Int. Cl. F02K 3/068; F02K 3/06

(52) U.S. Cl. CPC F02K 3/068; F02K 3/06

(57) ABSTRACT

The invention relates to a turbofan aircraft engine that comprises a primary duct including a combustion chamber; a first turbine disposed downstream of the combustion chamber; a compressor disposed upstream of the combustion chamber and coupled to the first turbine; and a second turbine disposed downstream of the first turbine and coupled to a fan for feeding a secondary duct of the turbofan aircraft engine. The bypass ratio of the inlet area of the secondary duct to the inlet area of the primary duct is at least 7 and the second turbine comprises at least two stages. The mean outer radius of the last stage of the second turbine divided by the length of the second turbine is at least 1.4.

### CROSS-REFERENCE TO RELATED APPLICATIONS

The present application claims the benefit under 35 U.S.C. 119(e) of U.S. Provisional Patent Application No. 62/263,227, filed Dec. 4, 2015, the entire disclosure of which is expressly incorporated by reference herein.

### BACKGROUND OF THE INVENTION

1. Field of the Invention

The present invention relates to a turbofan aircraft engine having a primary duct including a combustion chamber, a first turbine disposed downstream of the combustion chamber, a compressor disposed upstream of the combustion chamber and coupled to the first turbine, and a second turbine which is disposed downstream of the first turbine and coupled to a fan for feeding a secondary duct. The invention further relates to a passenger jet for at least 10 passengers which has a turbofan aircraft engine of this type, as well as to a method for reducing the noise emission of a turbofan aircraft engine.

2. Discussion of Background Information

Today, most engines of modem passenger jets are turbofan aircraft engines. In order to increase the efficiency and/or to reduce the noise emission thereof, so-called “geared turbofans” are known. In such geared turbofans, the fan and the turbine driving it are coupled via a speed reduction mechanism. While corresponding engines show a good efficiency at a satisfactory level of noise emission, there still is a desire to further improve the efficiency and/or further reduce the noise emission of turbofan aircraft engines.

### SUMMARY OF THE INVENTION

The present invention provides a turbofan aircraft engine which comprises a primary duct including a combustion chamber; a first turbine disposed downstream of the combustion chamber; a compressor disposed upstream of the combustion chamber and coupled to the first turbine; and a second turbine disposed downstream of the first turbine and coupled (via a speed reduction mechanism) to a fan for feeding a secondary duct of the turbofan aircraft engine, the bypass ratio of the inlet area of the secondary duct to the inlet area of the primary duct being at least 7. The second turbine comprises at least two stages, i.e., at least a first stage and a last stage, and has a length 1, the quotient r/1 of the mean outer radius r of the last stage of the second turbine divided by the length 1 of the second turbine being at least 1.4.

In one aspect of the turbofan aircraft engine of the present invention, the bypass ratio may be at least 7.5, e.g., at least 8, at least 8.5, or at least 9.

In another aspect, the quotient r/1 may be at least 1.41.

In yet another aspect of the engine, the quotient r/1 may be not higher than 2.1, e.g., not higher than 2.0, or not higher than 1.7.

In a still further aspect of the engine, the second turbine may comprise not more than three stages, e.g., may comprise exactly three stages.

In another aspect, 1 may be at least 5 inches and/or not more than 20 inches and/or r may range from 9 to 25 inches.

In another aspect of the turbofan aircraft engine, the first turbine may comprise at least two stages, e.g., may comprise exactly two stages.

The present invention also provides a passenger jet for at least ten passengers, e.g., for at least 50 passengers. The jet comprises the turbofan aircraft engine of the present invention as set forth above, including the various aspects thereof as set forth above.

The present invention further provides a method of reducing the noise level of a turbofan aircraft engine that comprises a primary duct including a combustion chamber, a first turbine disposed downstream of the combustion chamber, a compressor disposed upstream of the combustion chamber and coupled to the first turbine, and a second turbine disposed downstream of the first turbine and coupled to a fan for feeding a secondary duct of the turbofan aircraft engine, the bypass ratio of the inlet area of the secondary duct to the inlet area of the primary duct being at least 7 and the second turbine comprising at least a first stage and a last stage. The method comprises adjusting the mean outer radius r of the last stage of the second turbine and the length 1 of the second turbine so that a quotient r/1 is at least 1.4.

As set forth above, the turbofan aircraft engine according to the instant invention comprises a primary duct including a combustion chamber; a first turbine disposed downstream of the combustion chamber; a compressor disposed upstream of the combustion chamber and coupled to the first turbine; and a second turbine disposed downstream of the first turbine and coupled to a fan for feeding a secondary duct of the aircraft engine.

In one embodiment, the turbofan aircraft engine according to the instant invention may be a turbofan aircraft engine as disclosed in U.S. patent application Ser. No. 14/450,882 and/or in U.S. patent application Ser. No. 14/355,107, the entire disclosures of which are incorporated by reference herein.

The turbofan aircraft engine disclosed in U.S. patent application Ser. Nos. 14/450,882 and 14/355,107 is a turbofan aircraft engine having a primary duct (C) including a combustion chamber (BK), a first turbine (HT) disposed downstream of the combustion chamber, a compressor (HC) disposed upstream of the combustion chamber and coupled (W1) to the first turbine, and a second turbine (L) disposed downstream of the first turbine and coupled via a speed reduction mechanism (G) to a fan (F) for feeding a secondary duct (B) of the turbofan aircraft engine.

In one aspect thereof, the turbofan aircraft engine thus has a primary gas duct (hereinafter also referred to as “primary duct”) for a so-called “core flow.” The primary duct includes a combustion chamber, in which, in one embodiment, air that is drawn-in and compressed is burned together with supplied fuel during normal operation. The primary duct includes a first turbine which is located downstream, in particular immediately downstream, of the combustion chamber and which, without limiting generality, is hereinafter also referred to as “high-pressure turbine”. The axial location information “downstream” refers in particular to a through-flow during, in particular, steady-state operation and/or normal operation. The first turbine or high-pressure turbine may have one or more turbine stages, each including a rotor blade array and preferably a stator vane array downstream or upstream thereof, and is coupled, in particular fixedly connected, to a compressor of the primary duct such that they rotate at the same speed. The compressor is preferably disposed immediately upstream of the combustion chamber and, without limiting generality, is hereinafter also referred to as “high-pressure compressor”. The high-pressure compressor may have one or more stages, each including a rotor blade array and preferably a stator vane array downstream or upstream thereof. The high-pressure compressor, combustion chamber and high-pressure turbine together form a so-called “core engine.”

The turbofan aircraft engine has a secondary duct, which is preferably arranged fluidically parallel to and/or concentric with the primary duct. A fan is disposed upstream of the secondary duct to draw in air and feed it into the secondary duct. The fan may have one or more axially spaced-apart rotor blade arrays; i.e., rows of rotor blades distributed, in particular equidistantly distributed, around the circumference thereof. A stator vane array may be disposed upstream and/or downstream of each rotor blade array of the fan. En one embodiment, the fan is an upstream-most or first or forwardmost rotor blade array of the engine, while in another embodiment, the fan is a downstream-most or last or rearwardmost rotor blade array of the engine (“aft fan”). In one embodiment, the fan is adapted or designed to feed also the primary duct and/or is preferably disposed immediately upstream of the primary duct and/or the secondary duct. At least one additional compressor may be disposed between the fan and the first compressor or high-pressure compressor. Without limiting generality, the additional compressor is also referred to as “low-pressure compressor.”

The fan is coupled (via a speed reduction mechanism) to a second turbine of the primary duct. The second turbine is disposed downstream of the high-pressure turbine and, without limiting generality, is hereinafter also referred to as “low-pressure turbine”. The second turbine or low-pressure turbine may have two or more turbine stages, each including a rotor blade array and preferably a stator vane array downstream or upstream thereof. In one embodiment, at least one additional turbine may be disposed between the high-pressure and low-pressure turbines. In one embodiment, the fan and the low-pressure or second turbine may be coupled via a low-pressure shaft disposed concentrically with a hollow shaft, which couples the high-pressure compressor and the high-pressure turbine. The speed reduction mechanism may include a transmission, in particular, a single- or multi-stage gear drive. In one embodiment, the speed reduction mechanism may have an in particular fixed speed reduction ratio of at least 2:1, in particular at least 3:1, and/or not greater than 11:1, in particular not greater than 4:1, between a rotational speed of the low-pressure turbine and a rotational speed of the fan. As used herein, a speed reduction mechanism is understood to mean, in particular, a non-rotatable coupling which converts a rotational speed of the low-pressure turbine to a lower rotational speed of the fan.

In accordance with the present invention, the second turbine of the turbofan aircraft engine has at least two stages. In the last stage, (in the direction of through-flow during, in particular, steady-state operation and/or normal operation) the quotient r/1 of the mean outer radius r divided by the length 1 of the second turbine is at least 1.4. The term “mean outer radius r of the last stage” as used herein and in the appended claims is the distance between the (low-pressure) shaft (in particular, its axis of rotation) and the average of (i) the penetration point of the leading edge of a rotor blade of the last stage with the radially inner annular space and (ii) the penetration point of the trailing edge of the rotor blade with the radially outer annular space. The term “length of the second turbine” as used herein and in the appended claims is the axial length of the second turbine from the leading edge of the first rotor blade to the trailing edge of the last rotor blade of the second turbine. Merely by way of example, if a rotor blade of the last stage has a mean outer radius r of 12 inches and the length 1 of the second turbine is 8 inches, the quotient r/1 is 12/8=1.5.

As set forth above, the bypass ratio in the turbofan aircraft engine of the present invention is at least 7, but will often be at least 8, e.g., at least 9, at least 10, or at least 11.

Also, the quotient r/1 of the second turbine will often be higher than 1.4, e.g., at least 1.41, at least 1.45, at least 1.5 or at least 1.55. It will often not be higher than 2.1, e.g., not higher than 2.05, or not higher than 2.0.

The number of stages of the second turbine is not particularly limited, as long as it is at least two. Often the number of stages will be higher than two, e.g., three, four or five stages. For example, the second turbine may have three stages.

The length 1 of the second turbine also is not particularly limited, but will often be at least 5 inches, e.g., at least 7 inches, or at least 8 inches. 1 will often not be higher than 20 inches, e.g., not higher than 18 inches, or not higher than 16 inches.

The mean outer radius r of the last stage of the second turbine also is not particularly limited, but will often be at least 9 inches, e.g., at least 10 inches, or at least 10.5 inches. It will usually be not higher than 25 inches, e.g. not higher than 23 inches, or not higher than 20 inches.

The number of stages of the first turbine of the turbofan aircraft engine of the present invention is not particularly limited, but will usually be at least two (and more often exactly two).

As set forth above, the turbofan aircraft engine according to the instant invention comprises a primary duct including a combustion chamber; a first turbine disposed downstream of the combustion chamber; a compressor disposed upstream of the combustion chamber and coupled to the first turbine; and a second turbine disposed downstream of the first turbine and coupled to a fan for feeding a secondary duct of the aircraft engine.

By selecting a suitable relationship between the initially substantially independent design parameters of mean outer radius r of the last stage of the second turbine and length 1 of the second turbine it is possible to design a turbofan aircraft engine with a bypass area ratio of at least 7 that is particularly advantageous, in particular low-noise, efficient and/or compact. As used herein, the inlet area of the primary or secondary duct is understood to mean, in particular, the flow-through cross-sectional area at the inlet of the primary or secondary duct, preferably downstream, in particular immediately downstream, of the fan and/or at the same axial position.

### BRIEF DESCRIPTION OF THE DRAWING

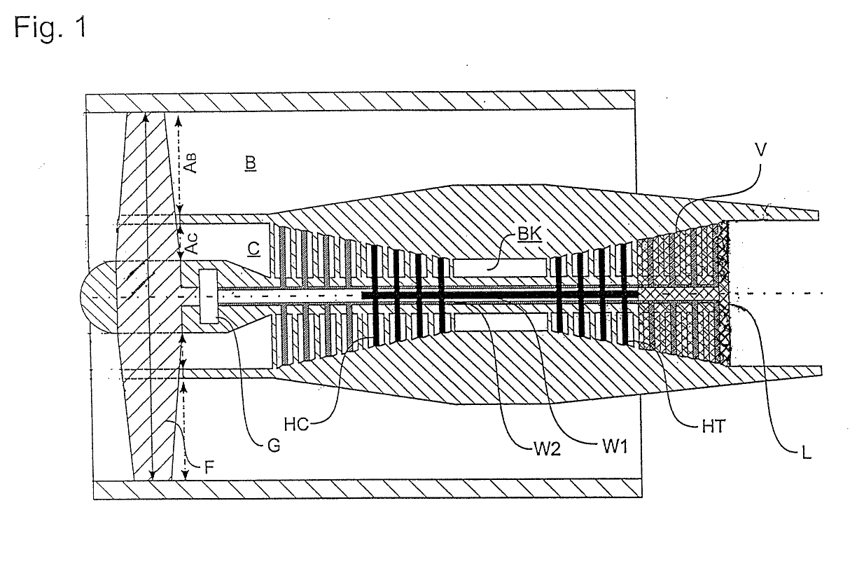

The only FIGURE (FIG. 1) shows, in partially schematic form, a turbofan aircraft engine of a passenger jet according to an embodiment of the present invention as set forth above.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawing making apparent to those of skill in the art how the several forms of the present invention may be embodied in practice.

FIG. 1 depicts a turbofan aircraft engine of a passenger jet in accordance with an embodiment of the present invention. The engine has a primary duct C containing a combustion chamber BK. The primary duct has a first turbine or high-pressure turbine HT, which is located immediately downstream (to the right in FIG. 1) of the combustion chamber and includes a plurality of turbine stages. The high-pressure turbine is fixedly coupled to a high-pressure compressor HC of the primary duct via a hollow shaft W1, and hence such that they rotate at the same speed, the high-pressure compressor being disposed immediately upstream of the combustion chamber. As used herein, a coupling providing for rotation at the same speed is understood to mean, in particular, a non-rotatable coupling having a constant gear ratio equal to one, such as is provided, for example, by a fixed connection.

The turbofan aircraft engine has a secondary duct B, which is arranged fluidically parallel to and concentric with the primary duct. A fan F is disposed immediately upstream of the primary and secondary ducts (to the left in FIG. 1) to draw in air and feed it into the primary and secondary ducts. An additional compressor or low-pressure compressor is disposed between the fan and the high-pressure compressor.

The fan is connected through a speed reduction mechanism including a transmission G and via a low-pressure shaft W2 to a second turbine or low-pressure turbine L of the primary duct. The low-pressure turbine includes a plurality of turbine stages and is disposed downstream of the high-pressure turbine (to the right in FIG. 1). The hollow shaft W1 is concentric with the low-pressure shaft W2.

Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

The entire disclosure of the co-pending application having the title “REDUCED NOISE TURBOFAN AIRCRAFT ENGINE” (Attorney Docket 6570-P50292), filed concurrently herewith, is incorporated by reference herein.

### LIST OF REFERENCE NUMERALS

A_{B} inlet area of the secondary duct
A_{C} inlet area of the primary duct
B secondary duct (bypass)
BK combustion chamber
C primary duct (core)
F fan
G transmission (speed reduction mechanism)
HC (high-pressure) compressor
HT first turbine or high-pressure turbine
L second turbine or low-pressure turbine
V volume
W1 hollow shaft
W2 low-pressure shaft

What is claimed is:

1. A turbofan aircraft engine, wherein the engine comprises:
a primary duct including a combustion chamber;
a first turbine disposed downstream of the combustion chamber;
a compressor disposed upstream of the combustion chamber and coupled to the first turbine; and
a second turbine disposed downstream of the first turbine and coupled to a fan for feeding a secondary duct of the turbofan aircraft engine, a bypass ratio of an inlet area of the secondary duct to an inlet area of the primary duct being at least 7;
and wherein the second turbine comprises at least a first stage and a last stage and has a length 1, a quotient r/1 of a mean outer radius r of the last stage divided by the length 1 being at least 1.4.

2. The turbofan aircraft engine of claim 1, wherein the bypass ratio is at least 7.5.

3. The turbofan aircraft engine of claim 1, wherein the bypass ratio is at least 8.

4. The turbofan aircraft engine of claim 1, wherein r/1 is at least 1.41.

5. The turbofan aircraft engine of claim 1, wherein r/1 is not higher than 2.1.

6. The turbofan aircraft engine of claim 1, wherein r/1 is not higher than 2.0.

7. The turbofan aircraft engine of claim 1, wherein r/1 is not higher than 1.7.

8. The turbofan aircraft engine of claim 3, wherein r/1 is at least 1.41.

9. The turbofan aircraft engine of claim 1, wherein the second turbine comprises not more than three stages.

10. The turbofan aircraft engine of claim 9, wherein the second turbine comprises three stages.

11. The turbofan aircraft engine of claim 1, wherein 1 is at least 5 inches.

12. The turbofan aircraft engine of claim 1, wherein 1 is not more than 20 inches.

13. The turbofan aircraft engine of claim 1, wherein r ranges from 9 to 25 inches.

14. The turbofan aircraft engine of claim 1, wherein the first turbine comprises at least two stages.

15. The turbofan aircraft engine of claim 1, wherein the first turbine comprises two stages.

16. A passenger jet for at least ten passengers, wherein the jet comprises the turbofan aircraft engine of claim 1.

17. A method of reducing the noise level of a turbofan aircraft engine that comprises a primary duct including a combustion chamber, a first turbine disposed downstream of the combustion chamber, a compressor disposed upstream of the combustion chamber and coupled to the first turbine, and a second turbine disposed downstream of the first turbine and coupled to a fan for feeding a secondary duct of the turbofan aircraft engine, a bypass ratio of an inlet area of the secondary duct to an inlet area of the primary duct being at least 7 and the second turbine comprising at least a first stage and a last stage, wherein the method comprises adjusting a mean outer radius r of the last stage of the second turbine and the length 1 of the second turbine so that a quotient r/1 is at least 1.4.
